(19) United States
(12) Patent Application Publication
(10) Pub. No.: US 2016/0216424 A1
(43) Pub. Date: Jul. 28, 2016

(54) POLARIZING PLATE HAVING PROTECTIVE LAYER AND DISPLAY DEVICE INCLUDING THE SAME

(71) Applicant: DONGWOO FINE-CHEM CO., LTD., Jeollabuk-do (KR)

(72) Inventors: Yong Won SEO, Gyeonggi-do (KR); Hong Jun AHN, Seoul (KR); Ji Hye HEO, Gyeonggi-do (KR)

(21) Appl. No.: 15/006,182

(22) Filed: Jan. 26, 2016

(30) Foreign Application Priority Data
Jan. 27, 2015 (KR) 10-2015-0012451

(51) Int. Cl. G02B 5/30; G02B 1/14

(52) U.S. Cl. CPC G02B 5/3016; G02B 1/14

(57) ABSTRACT

A polarizing plate includes an adhesive layer, a protective layer made of an aqueous composition containing polyvinylalcohol, and a polarizer which are laminated in this order, and the polarizer includes a liquid crystal coating layer which is formed on one surface of a base film thereof. The polarizing plate having the above configuration may exhibit increased durability and maintain optical characteristics, and thereby implementing high image quality in the display device with increased durability.

### CROSS REFERENCE TO RELATED APPLICATION AND CLAIM OF PRIORITY

This application claims priority to and the benefit of Korean Patent Application No. 10-2015-0012451 filed on Jan. 27, 2015 in the Korean Intellectual Property Office, the entire contents of which are incorporated herein by reference.

### BACKGROUND

1. Field of the Invention

The present invention relates to a polarizing plate having excellent durability and stable optical performance, and a display device including the same.

2. Description of the Related Art

Recently, with the development of optical techniques, display device-related techniques using various schemes such as a plasma display panel (PDP), a liquid crystal display (LCD), organic/inorganic electroluminescent displays (ELD), and the like for replacing a conventional cathode-ray tube have been proposed and commercially available. In the above-described display device, the use of various plastic films is proposed, and required characteristics are sophisticated over time. For example, in the case of the liquid crystal display, various plastic films are used in a polarizing plate, a retardation film, a plastic substrate, a light guide plate, and the like, in order to implement thin and lightweight of the display and improve display characteristics.

The polarizing plate is an optical device for converting a natural light or any polarized light into a polarized light in a specific direction, in which unpolarized light emitted from a light source of the display device passes through the polarizing plate and only linearly polarized light is incident on a liquid crystal cell. Thereby, intensity of the transmitted light is controlled depending on a degree of rotation of a polarization axis of incident light, and grayscale (between black and white) representation is enabled. That is, the polarizing plate is one of key components making it possible to visually confirm an image implemented in a flat panel display device.

Generally, the polarizing plate has a structure in which a triacetyl cellulose film (hereinafter, referred to as a TAC film), serving as a protective film, is laminated on a polarizer manufactured by a method for dyeing a polyvinylalcohol film with iodine or dichroic dye, stretching in a predetermined direction and cross-linking the dyed polyvinylalcohol film, using an adhesive. However, both of the polyvinylalcohol film used as the polarizer and the TAC film used as the protective film for the polarizer are vulnerable to humidity of film itself, and have poor heat resistance and moisture resistance due to a manufacturing process such as stretching. Therefore, if the polarizing plate including the foregoing films is used under a high temperature or high humidity atmosphere over a long time, a degree of polarization is decreased, and the protective film is delaminated from the polarizer or optical properties are deteriorated. Accordingly, the polarizer with these films is largely limited in uses.

Further, the TAC film shows a significant change in existing values of an in-plane retardation (Rᵢₙ) and a thickness retardation (Rₜₕ) due to a change in surrounding temperature/humidity environments, in particular, involves a considerable change in the retardation relative to the incident light in an inclined direction. When a polarizing plate including the protective film of a triacetylcellulose film having such characteristics is employed in the liquid crystal display device, viewing angle characteristics are changed depending on the surrounding temperature/humidity environments, which in turn, cause a problem of deteriorating image quality. In addition, since the TAC film also has a relatively large photoelastic coefficient value, a change in retardation characteristics is locally generated after evaluation of durability in heat resistant and moisture resistant environments, thereby the image quality may be deteriorated.

As a material to compensate for such various drawbacks of the TAC films, a methacrylic resin is well known in the related art. However, it is known that since the methacrylic resin is easily broken or cracked, there is a problem of poor transportability at the time of manufacturing the polarizing plate, resulting in insufficient productivity. Further, when using an acrylate resin as a material of the film, since it is required to use a casting method, there are problems in that the manufacturing method is difficult and manufacturing costs are increased.

The adhesive is used to attach the polarizer and the protective film. Specifically, the adhesive includes an acrylic UV-curable adhesive, a dry laminating adhesive which is a mixture of a urethane resin solution and a polyisocyanate resin solution, a styrene butadiene rubber adhesive, an epoxy adhesive, a polyvinylalcohol adhesive, a urethane adhesive, an adhesive containing a compound having a polyester ionomer type urethane resin and a glycidyloxy group, a thermosetting adhesive, or the like.

Among these adhesives, an aqueous adhesive has a limitation in an adhesive strength thereof depending on a material of the protective film, such that additional alkali treatment, corona treatment, or the like is performed on a surface of the protective film. In addition, when the material of the protective film is different, problems such as curling of the polarizing plate, deterioration in initial optical properties may occur. In order to complement disadvantages of the aqueous adhesive, a non-aqueous adhesive has been developed.

However, in the case of the non-aqueous adhesive, when using the thermosetting adhesive or photocurable adhesive, a separate curing process is required. In particular, a photocuring process may damage the polarizing plate. Generally, since the non-aqueous adhesive has a high viscosity, a thickness of the formed adhesive layer increases, which may cause problems in that wrinkles occur on the polarizing plate, or the polarizing plate breaks due to an increased fragility.

Korean Patent Registration No. 10-1459126 discloses an adhesive composition exhibiting a little change depending on heat and humidity, and an excellent adhesive strength while being interposed between a polarizer and a protective film. In this case, the used adhesive composition includes a polyvinylalcohol resin, a zirconium compound, and an imine type cross-linking agent to improve durability and water resistance of the polarizing plate.

Japanese Patent Laid-Open Publication No. 2004-334168 discloses a polarizing plate in which a protective film made of a cycloolefin resin is laminated on a polyvinylalcohol polarizer through an adhesive containing a urethane adhesive and a polyvinylalcohol resin. However, the cycloolefin resin may be easily eroded by an organic solvent such as acetone, toluene, ethyl acetate, or the like. Since such organic solvent is used in the manufacturing of a non-aqueous adhesive, the organic solvent may remain in the adhesive in some cases.

According to the above-described patents, a problem of deterioration in durability of the polarizing plate generated due to the adhesive or the protective film may be solved in some degree, but it is insufficient in terms of an effect thereof. A material and a method used to manufacture the polarizing plate in the related art have a limitation in implementing a display device having a thin thickness and light weight which is recently demanded.

Meanwhile, Korean Patent Laid-Open Publication No. 2013-0008466 discloses a method for manufacturing a polarizing plate by coating a polarizer with a liquid crystal compound capable of exhibiting polarization characteristics. In the case of this method, it could be confirmed that, since polyvinylalcohol is not used, and a stretching process is not executed, the above-described problems may be essentially solved. However, the polarizing layer may be deteriorated due to factors of an external environment to which the polarizing plate is exposed during manufacturing or using, and thereby it is necessary for the polarizing layer to be formed a protective layer thereon.

### SUMMARY

As a result of conducting diversified researches in order to manufacture a polarizing plate having a protective layer capable of reliably maintaining optical performance while having high water resistance and heat resistance, when forming the protective layer on the polarizing plate using an aqueous composition containing polyvinylalcohol, the optical performance may be effectively maintained by a simple process even without an adhesive or additional protective film. Further, when manufacturing a polarizer by coating a base film with a liquid crystal compound capable of exhibiting polarization characteristics, a stretching process is not executed such that durability does not deteriorates. Accordingly, one or more embodiments of the present invention has been completed on the basis of the finding that the above-described problems may be solved.

In order to accomplish the above objects, according to an aspect of the present invention, there is provided a polarizing plate including an adhesive layer, a protective layer, and a polarizer which are laminated in this order, wherein the protective layer is made of an aqueous composition containing polyvinylalcohol, and the polarizer includes a liquid crystal coating layer which has alignment property offered by a non-stretching method and is formed on one surface of a base film thereof.

Herein, the polyvinylalcohol may be included in an amount of 1 to 10% by weight, to 100% by weight of the aqueous composition.

The protective layer may be formed by applying the aqueous composition and then drying the same.

Further, the protective layer may have a thickness of 0.5 to 3.0 μm after drying.

Further, the base film may be a transparent polymer film.

In addition, the liquid crystal coating layer may include a polymerizable liquid crystal compound and a dichroic dye.

Further, the adhesive layer may include one selected from a group consisting of an acrylic copolymer, epoxy resin, urethane resin, silicon resin, polyether resin, polyester resin, polyamide resin, polyvinylalcohol resin, and a combination thereof.

Furthermore, a change amount of transmittance before and after being left under a high temperature or high humidity atmosphere may be 1.0% or less.

Furthermore, a change amount of degree of polymerization before and after being left under a high temperature or high humidity atmosphere may be 1.0% or less.

According to another aspect of the present invention, there is provided a display device including: the above-described polarizing plate.

Accordingly, it is an aspect of the present invention to provide a polarizing plate having stable optical performance and capable of securing excellent durability.

In addition, another aspect of the present invention is to provide a display device including the polarizing plate.

The polarizing plate according to an embodiment of the present invention may solve a problem of deterioration in the optical performance using the protective layer made of the aqueous composition containing polyvinylalcohol.

Further, the polarizing plate may solve a problem of decrease in durability due to the manufacturing process.

Further, the polarizing plate may be applied to various display devices to implement high image quality.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a cross-sectional view illustrating a polarizing plate according to an embodiment of the present invention.

### DETAILED DESCRIPTION

An embodiment of the present invention discloses a polarizing plate having improved heat resistance, moisture resistance, and durability to have stable optical characteristics.

A polarizer is manufactured using a hydrophilic resin such as polyvinylalcohol, thus is generally vulnerable to moisture. In addition, during manufacturing the polarizer, a stretching process is executed in order to allow the polarizer to have polarization performance. Since the stretching is performed under high temperature or humidity condition, a deformation such as contraction or fracture may easily occur, which causes deterioration in durability and optical characteristics of the polarizing plate. By laminating a protective film on the polarizer, the physical properties of the polarizing plate may be improved in a desired level. However, in order to attach the protective film, an adhesive having excellent adhesive strength with respect to both of the polarizer and the protective film is required. As a result, various adhesives have been used, but problems such as an increase in a thickness of the polarizing plate, defective appearance, performance deterioration, and the like may occur due to an increase in the number of laminated layers, and a change in physical properties such as adhesive strength.

In consideration of this circumstance, according to an embodiment of the present invention, the protective layer is made of a mixture of water and polyvinylalcohol, and the polarizer is prepared by coating one surface of a base film with a liquid crystal layer, thereby solving the above-described problems.

Hereinafter, exemplary embodiments of the present invention will be described in more detail with reference to accompanying drawings. However, the accompanying drawings in the present specification are merely examples for describing the present invention. Thus, the present invention is not limited to the drawings. In addition, for the convenience of description, some of components may be exaggerated, minimized, or omitted in the drawings.

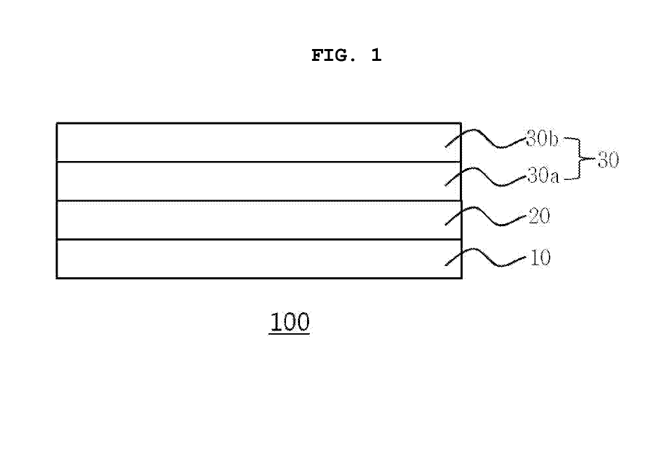

FIG. 1 is a cross-sectional view illustrating a polarizing plate according to an embodiment of the present invention.

Referring to FIG. 1, a polarizing plate 100 according to the embodiment of the present invention has a structure in which an adhesive layer 10, a protective layer 20, and a polarizer 30 are laminated in this order.

In this case, the protective layer 20 of an aqueous composition containing polyvinylalcohol is formed on the polarizer 30, and serves to maintain the optical performance and prevent the polarizer formed by a coating process from being exposed to an external environment, and thereby protecting the polarizer. Specifically, the protective layer 20 prevents the deterioration in optical performance such as transmittance, a degree of polarization, or the like of the polarizer. Further, since the protective layer 20 replaces a protective film, and an adhesive used in the conventional polarizing plate, thinning of the polarizing plate may be achieved.

The aqueous composition contains polyvinylalcohol and water.

Polyvinylalcohol, as a vinyl polymer, has excellent adhesive properties, and has a hydroxyl group in a polymer repeating unit to express hydrophilicity and have significantly stable chemical properties. Also, it is easy to form a network through a cross-linking bond, such that it may be easily applied to a surface. Accordingly, any polyvinylalcohol may be used so long as it may be sufficiently applied to the polarizer, and have excellent optical transparency without a change such as yellowing over time without particular limitation thereof. For example, polyvinylalcohol prepared by saponification of poly vinyl acetate, and its derivatives; a saponified copolymer of a monomer additionally having copolymerization property with vinyl acetate; and denatured polyvinylalcohol prepared by acetalization, urethanization, etherification, graftication, and phosphoric esterification of poly vinyl alcohol, or the like may be used.

The monomer may include unsaturated carboxylic acid such as (anhydrous) maleic acid, fumaric acid, crotonic acid, itaconic acid, (meth) acrylic acid, and its esters, α-olefin such as ethylene, and propylene, (meth) allylsulfonic acid (soda), sulfonic acid soda (monoalkyl maleate), disulfonic acid soda alkyl maleate, N-methylol acrylamide, acrylamide alkyl sulfonic acid alkali salt, N-vinyl pyrrolidone, N-vinyl pyrrolidone derivatives, or the like. The above polyvinylalcohol may be used alone or in combination of two or more thereof.

The polyvinylalcohol may be used in an amount of 1 to 10% by weight (‘wt. %’), and preferably, 2 to 5 wt. % to 100 wt. % of the aqueous composition. If the content thereof is less than the above range, an effect of protecting the polarizer may be insufficient. On the other hand, if the content thereof exceeds the above range, coating property or stability may be deteriorated.

The aqueous composition for preparing the protective layer 20 according to an embodiment of the present invention may form a uniform layer by using water as a solvent, and it is very preferable in terms of coating property and stability. In addition, water which is a solvent for making the layer may be easily removed through drying, manufacturing process is significantly economical, thus having economical advantages in aspects of processing costs

The aqueous composition may further include an additive generally used in the related art such as a plasticizer, a silane coupling agent, an antistatic agent, a leveling agent, a basic material, or the like, in a range which does not inhibit the desired effects in the present invention.

A method for preparing the protective layer 20 includes applying the above-described aqueous composition and then drying the same. As a method for applying the aqueous composition, any method generally known in the related art may be used. For example, the application method may include extrusion coating, direct gravure coating, reverse gravure coating, CAP coating, die coating, dip coating, bar coating, and spin-coating. The drying is performed by, for example, heat drying. A drying temperature is appropriately selected from a range of 50 to 200° C., and preferably, 80 to 150° C. A drying time of one to five minutes is appropriate. If the drying temperature and drying time are out of the above range, application quality may be deteriorated.

A thickness of the protective layer 20 after the drying is 0.5 to 3.0 μm, and preferably, 0.7 to 1.5 μm. If the thickness of the protective layer 20 is less than 0.5 μm, effects as the protective layer may not be obtained, while if the thickness thereof exceeds 3.0 μm, the polarizing plate may have defective appearance.

The polarizer 30 used in the polarizing plate of an embodiment of the present invention has a form in which a liquid crystal coating layer 30a having alignment property offered by a non-stretching method is applied on one surface of a base film 30b. Accordingly, since the stretching process performed on the polarizing plate in the related art is not executed, deterioration in durability, and deterioration in optical characteristics such as transmittance, degree of polarization resulting therefrom may be improved.

As the base film 30b may use any film generally used in the related art as an optical transparent film without particular limitation thereof. But, it is preferable to use a film having excellent transparency, mechanical strength, thermal stability, moisture shielding property, retardation uniformity, isotropic property, and the like.

As a material of the base film 30b, a transparent polymer film may be used. Specifically, any one selected from a group consisting of: polyolefin resin, polyester resin, cellulose resin, polycarbonate resin, acryl resin, styrene resin, vinyl chloride resin, amide resin, imide resin, polyether sulfone resin, sulfone resin, polyetherether sulfone resin, polyetherether ketone resin, polyphenylene sulfide resin, vinylalcohol resin, vinylidene chloride resin, vinylbutyral resin, allylate resin, polyoxymethylene resin and epoxy resin, may be used. Preferably, any one selected from a group consisting of triacetyl cellulose (TAC), polyacrylate (PAC), polyethylene terephthalate (PET), polycarbonate (PC), polyethylene (PE), a norbonene derivative, and a combination thereof may be used.

When using the base film 30b, the polarizing plate may be prevented from being damaged during manufacturing, carrying, and storing the polarizing plate, and may be easily handled.

A thickness of the base film 30b is not limited to a specific range, but in general, may be, for example, 5 to 100 μm, and preferably, 15 to 60 μm. If the thickness of the base film 30b is less than 5 μm, mechanical strength of the film may decreased, while if the thickness thereof exceeds 100 μm, it may hinder thinning of the polarizing plate, thus is not preferable.

The liquid crystal coating layer 30a is prepared by applying a composition for a liquid crystal coating layer to one surface of the base film 30b.

The composition for a liquid crystal coating layer includes a polymerizable liquid crystal compound and a dichroic dye.

The polymerizable liquid crystal compound refers to a compound having liquid crystal phase by including mesogen capable of exhibiting liquid crystallinity and an end group which is polymerizable therewith. When polymerizing the compound, a cross-linked polymer film in which the alignment property of the liquid crystal phase is maintained may be obtained. The liquid crystal phase aligned in a predetermined direction serves to convert natural light incident from an outside into a desired single polarized state. Further, a film prepared by the cross-linking of the polymerizable end group maintains the formed liquid crystal phase, and has a solid-phase film form, thus is mechanically or thermally stable.

The polymerizable liquid crystal compound is a polymerizable liquid crystal compound which represents a smectic phase. The smectic phase may include smectic A phase, smectic B phase, smectic D phase, smectic E phase, smectic F phase, smectic G phase, smectic H phase, smectic I phase, smectic J phase, and smectic K phase. Among them, the smectic B phase, smectic F phase, and smectic I phase are preferably used, and the smectic B phase is more preferably used. When the liquid crystal phase represented by the polymerizable liquid crystal includes the above-described liquid phases, it is possible to obtain an optical film having a high alignment order degree.

The polymerizable liquid crystal compound may include a compound represented by Formula 1 below.

U¹-V¹-W¹-X¹-Y¹-X²-Y²-X³-W²-V²-U² [Formula 1]

(In the above Formula 1, X¹, X² and X³ denote a p-phenylene group which may have a substituent or a cyclohexane-1,4-diyl group which may have a substituent. However, at least one of X¹, X² and X³ denotes a p-phenylene group which may have a substituent.

Y¹ and Y² each independently denote —CH₂CH₂—, —CH₂O—, —COO—, —OCOO—, a single bond, —N═N—, —CR^{a}═CR^{b}—, —C≡C—, or —CR^{a}═N—.

R^{a} and R^{b} each independently denote a hydrogen atom or an alkyl group having 1 to 4 carbon atoms.

U¹ denotes a hydrogen atom or a polymerizable group.

U² denotes a polymerizable group.

W¹ and W² each independently denote a single bond, —O—, —S—, —COO—, or —OCOO—.

V¹ and V² each independently denote an alkanediyl group having 1 to 20 carbon atoms which may have a substituent, and —CH₂— included in the alkanediyl group may be substituted by —O—, —S— or —NH—.)

X¹, X² and X³ are each independently a p-phenylene group which may have a substituent or a cyclohexane-1,4-diyl group which may have a substituent. However, at least one of X¹, X² and X³ is a 1,4-phenylene group which may have a substituent. Preferably, at least two of X¹, X² and X³ are a p-phenylene group which may have a substituent.

The p-phenylene group is preferably unsubstituted. The cyclohexane-1,4-diyl group is preferably a trans-cyclohexane-1,4-diyl group, and more preferably, is unsubstituted.

The substituent, which may be included in the p-phenylene, may include an alkyl group having 1 to 4 carbon atoms such as methyl, ethyl, butyl groups, and the like, cyano, and halogen groups (halogen atom).

The substituent, which may be included in the cyclohexane-1,4-diyl group, may include an alkyl group having 1 to 4 carbon atoms such as methyl, ethyl, butyl groups, and the like, cyano, and halogen groups (halogen atom). —CH₂— of the cyclohexane-1,4-diyl group may be substituted by —O—, —S— or NR—. Herein, R is an alkyl group or a phenyl group having 1 to 6 carbon atoms.

Y¹ and Y² are each independently —CH₂CH₂—, —CH₂O—, —COO—, —OCOO—, a single bond, —N═N—, —CR^{a}═CR^{b}—, —C≡C—, or —CR^{a}═N—. A bonding position of the groups may be in any direction. Preferably, Y¹ is —CH₂CH₂—, —COO— or a single bond, and Y² is —CH₂CH₂— or —CH₂O—.

R^{a} and R^{b} are each independently a hydrogen atom or an alkyl group having 1 to 4 carbon atoms. The alkyl group having 1 to 4 carbon atoms may include a methyl group, an ethyl group, a butyl group, or the like.

U¹ is a hydrogen atom, or a polymerizable group, and preferably, a polymerizable group.

U² is a polymerizable group. The polymerizable group may include vinyl, vinyloxy, 1-chlorovinyl, isoprophenyl, 4-vinylphenyl, acryloyloxy, methacryloyloxy, oxiranyl, oxetanyl groups, and the like. Among them, the acryloyloxy, methacryloyloxy, vinyloxy, oxiranyl, and oxetanyl groups are preferably used, and the acryloyloxy group is more preferably used. Herein, it is preferable that U¹ and U² are the same type of polymerizable groups.

W¹ and W² are each independently a single bond, —O—, —S—, —COO—, or —OCOO—, and preferably, a single bond or —O—.

V¹ and V² each independently denote an alkanediyl group having 1 to 20 carbon atoms which may have a substituent. —CH₂— included in the alkanediyl group may be substituted by —O—, —S— or —NH—. The alkanediyl group having 1 to 20 carbon atoms may include methylene, ethylene, propane-1,3-diyl, butane-1,3-diyl, butane-1,4-diyl, pentane-1,5-diyl, hexane-1,6-diyl, heptane-1,7-diyl, octane-1,8-diyl, decane-1,10-diyl, tetradecane-1,14-diyl, icosane-1,20-diyl groups, and the like. The alkanediyl group having 1 to 12 carbon atoms is preferably used, and the alkanediyl group having 6 to 12 carbon atoms is more preferably used. The substituent, which may be included in the alkanediyl group, may include cyano and halogen groups (halogen atom).

Specific compounds represented by the above Formula 1 are as follow.

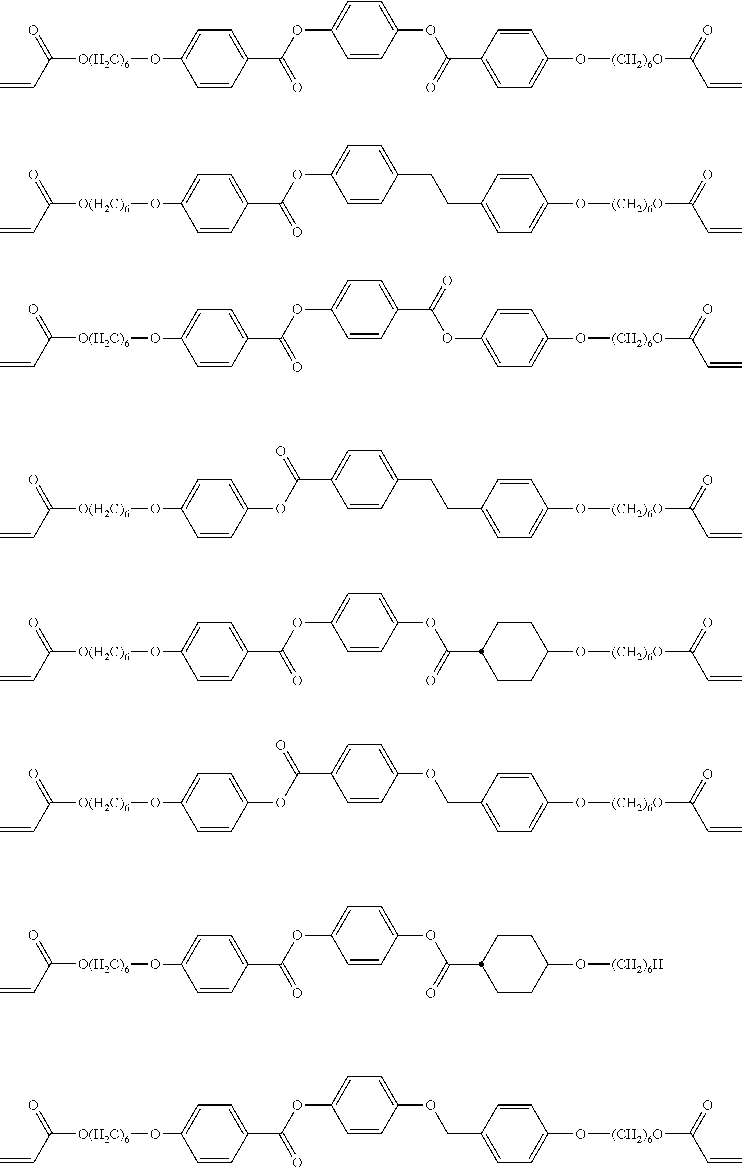

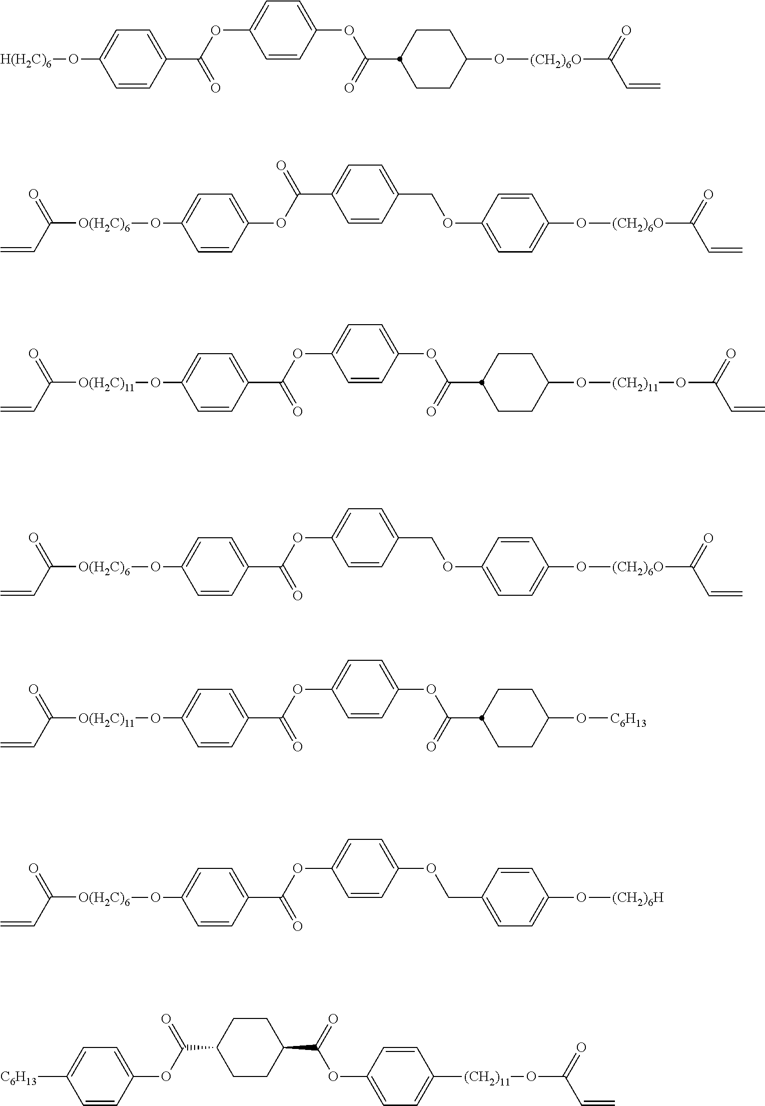

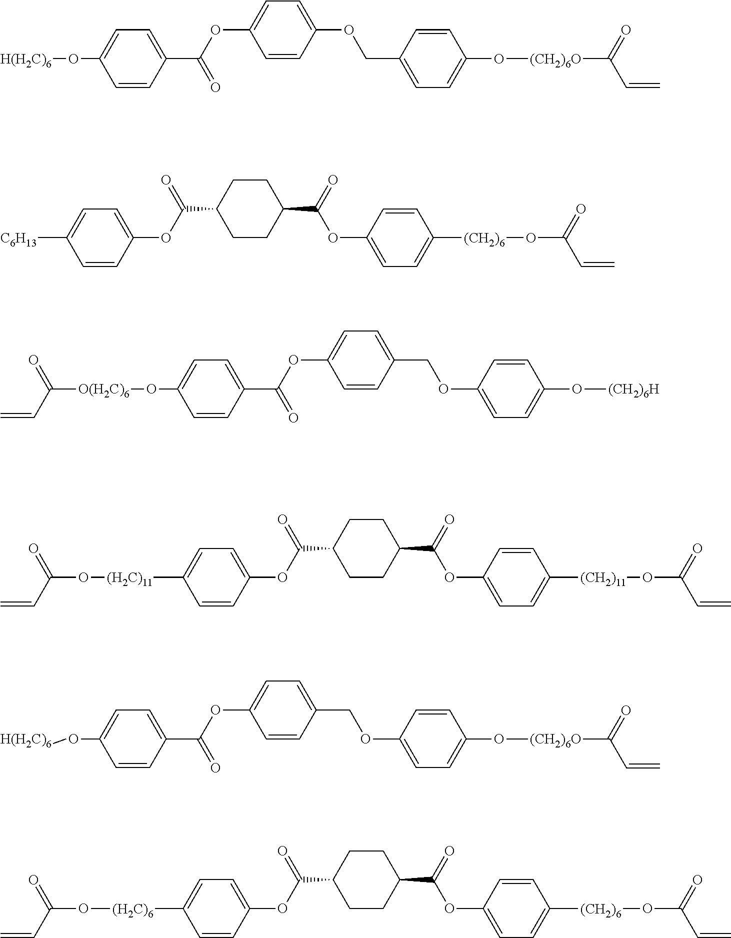

The polymerizable liquid crystal compound used in the present invention is not limited to the above examples, but any polymerizable liquid crystal compound known in the related art may be used so long as it satisfies the above-described conditions.

The dichroic dye, which is contained in the composition for a liquid crystal coating layer of an embodiment of the present invention to implement polymerization characteristics, is a dye of which absorbance in a major axis direction of a molecule and absorbance in a minor axis direction are different from each other.

As the dichroic dye, both of dyes and pigments may be used, and there is no particular limitation in the present invention. Preferably, any known dichroic dye having a maximum absorption wavelength of 300 to 700 nm may be used as the dichroic dye.

The dichroic dye may include any one selected from a group consisting of acridine dyes, oxazine dyes, cyanine dyes, a naphthalene dyes, azo dyes, anthraquinone dyes, and a combination thereof, the azo dyes are preferably used. Specifically, the azo dyes may include monoazo dyes, bisazo dyes, trisazo dyes, tetrakis azo dyes, and stilbene azo dyes.

A content of the dichroic dye is preferably, 50 parts by weight or less, more preferably, 0.1 to 20 parts by weight, and most preferably, 0.1 to 10 parts by weight, to 100 parts by weight of the polymerizable liquid crystal compound. Within the above range, polymerization may be performed without disturbing the alignment of the polymerizable liquid crystal compound. If the content of the dichroic dye exceeds 50 parts by weight, the alignment of the polymerizable liquid crystal compound may be disturbed.

The composition for a liquid crystal coating layer may further include a leveling agent, a polymerization initiator, and a solvent to secure efficiency of the coating process, and uniformity of the coating layer.

The leveling agent serves to control fluidity of the composition for a liquid crystal coating layer to flatten the formed film.

The leveling agent may use any one selected from a group consisting of a leveling agent having a polyacrylate compound as a major component, a leveling agent having a fluorine atom as a major component, and a combination thereof. Specifically, the leveling agent having a polyacrylate compound as a major component may include BYK-350, BYK-352, BYK-353, BYK-354, BYK-355, BYK-358N, BYK-361N, BYK-380, BYK-381, and BYK-392 (which are manufactured by BYK Chemie Co.), and the leveling agent having a fluorine atom as a major component may include Megaface R-08, Megaface R-30, Megaface R-90, Megaface F-410, Megaface F-411, Megaface F-443, Megaface F-445, Megaface F-470, Megaface F-471, Megaface F-477, Megaface F-479, Megaface F-482, Megaface F-483 (which are manufactured by DIC Co., Ltd.), Saffron S-381, Saffron S-382, Saffron S-383, Saffron S-393, Saffron SC-101, Saffron SC-105, KH-40, SA-100 (which are manufactured by AGC Seimi Chemical Co., Ltd.), E1830, E5844 (which are manufactured by Daikin industries, Ltd., fine chemical), FTOP EF301, FTOP EF303, FTOP EF351, FTOP, and EF352 (which are manufactured by Mitsubishi Materials Electronic Chemicals Co., Ltd.).

A content of the leveling agent may be 0.3 to 5 parts by weight, and preferably, 0.5 to 3 parts by weight to 100 parts by weight of the polymerizable liquid crystal compound. When the content of the leveling agent is within the above range, components contained in the composition for a liquid crystal coating layer may be easily horizontally aligned, and the flattened coating layer may be obtained. If the content of the leveling agent exceeds 5 parts by weight, smearing may easily occur in the liquid crystal coating layer.

The polymerization initiator is a compound adapted to initiate a polymerization reaction of the polymerizable liquid crystal compound, and generates an active radical or an acid by light and/or heat. Among them, it is preferable that the polymerization initiator is a polymerization initiator which generates an active radical or an acid by light, that is, a photopolymerization initiator.

As the photopolymerization initiator, general photo-radical initiators may be used without particular limitation. For example, an acetophenone compound, a benzoin compound, a benzophenone compound, a triazine compound, an anthraquinone compound, a thioxanthone compound, an anthracene compound, or the like may be used.

The acetophenone compound may include diethoxyacetophenone, 2-hydroxy-2-methyl-1-phenylpropan-1-on, benzyldimethylketal, 2-hydroxy-1-[4-(2-hydroxyethoxy)phenyl]-2-methylpropan-1-on, 1-hydroxycyclohexylphenylketone, 2-methyl-1-(4-methylthiophenyl)-2-morpholinopropan-1-on, 2-benzyl-2-dimethylamino-1-(4-morpholinophenyl)butane-1-on, 2-hydroxy-2-methyl-1-[4-(1-methylvinyl)phenyl]popan-1-on, or the like.

The benzoin compound may include benzoin methylether, benzoin ethylether, benzoin isopropyl ether, benzoin isobutyl ether, benzyldimethylketal, or the like.

The benzophenone compound may include 0-benzoylmethyl benzoate, 4-phenylbenzophenone, 4-benzoyl-4′-methyldiphenylsulfide, 3,3′,4,4′-tetra(tert-butylperoxycarbonyl)benzophenone, 2,4,6-trimethylbenzophenone, 4,4′-di(N,N′-dimethylamino)-benzophenone, or the like.

The triazine compound may include 2,4-bis(trichloromethyl)-6-(4-methoxyphenyl)-1,3,5-triazine, 2,4-bis(trichloromethyl)-6-(4-methoxynaphthyl)-1,3,5-triazine, 2,4-bis(trichloromethyl)-6-piperonyl-1,3,5-triazine, 2,4-bis(trichloromethyl)-6-(4-methoxystyryl)-1,3,5-triazine, 2,4-bis(trichloromethyl)-6-[2-(5-methylfuran-2-yl)ethenyl]-1,3,5-triazine, 2,4-bis(trichloromethyl)-6-[2-(furan-2-yl)ethenyl]-1,3,5-triazine, 2,4-bis(trichloromethyl)-6-[2-(4-diethylamino-2-methylphenyl)ethenyl]-1,3,5-triazine, 2,4-bis(trichloromethyl)-6-[2-(3,4-dimethoxyphenyl)ethenyl]-1,3,5-triazine, or the like.

The anthraquinone compound may include 2-ethyl anthraquinone, octamethyl anthraquinone, 1,2-benzanthraquinone, 2,3-diphenyl anthraquinone, or the like.

The thioxanthone compound may include 2-isopropylthioxanthone, 2,4-diethylthioxanthone, 2,4-dichlorothioxanthone, 1-chloro-4-propoxythioxanthone, or the like.

The anthracene compound may include 9,10-dimethoxyanthracene, 2-ethyl-9,10-dimethoxyanthracene, 9,10-diethoxyanthracene, 2-ethyl-9,10-diethoxyanthracene, or the like.

A thermal radical initiator is not particularly limited in the present invention, and a representative example thereof may include a peroxide compound, or an azo compound, it is not limited thereto.

The azo compound may use 2,2′-azobis(2-methylbutyronitrile), 2,2′-azobis (isobutyronitrile), 2,2′-azobis(2,4-dimethylvaleronitrile), 2,2′-azobis(4-methoxy-2,4-dimethylvaleronitrile), or the like.

Examples of the peroxide compound may include tetramethylbutylperoxy neodecanoate, bis(4-butylcyclohexyl)peroxydicarbonate, di(2-ethylhexyl)peroxy carbonate, butylperoxy neodecanoate, dipropyl peroxy dicarbonate, diisopropyl peroxy dicarbonate, diethoxyethyl peroxy dicarbonate, diethoxyhexylperoxy dicarbonate, hexyl peroxy dicarbonate, dimethoxybutyl peroxy dicarbonate, bis(3-methoxy-3-methoxybutyl) peroxy dicarbonate, dibutyl peroxy dicarbonate, dicetylperoxy dicarbonate, dimyristyl peroxy dicarbonate, 1,1,3,3-tetramethylbutyl peroxypivalate, hexyl peroxy pivalate, butyl peroxy pivalate, trimethyl hexanoyl peroxide, dimethyl hydroxy butyl peroxy neodecanoate, amyl peroxy neodecanoate, butyl peroxy neodecanoate, t-butylperoxyneoheptanoate, amylperoxy pivalate, t-butylperoxy pivalate, t-amyl peroxy-2-ethylhexanoate, lauryl peroxide, dilauryl peroxide, didecanoyl peroxide, benzoyl peroxide, dibenzoyl peroxide, or the like, but it is not limited thereto.

A content of the polymerization initiator is preferably 0.1 to 30 parts by weight, more preferably, 0.5 to 10 parts by weight, and most preferably, 0.5 to 8 parts by weight, to 100 parts by weight of the polymerizable liquid crystal compound.

Within the above range, polymerization may be performed without disturbing the alignment of the polymerizable liquid crystal compound.

The solvent is adapted to dissolve each component of the above-described composition for a liquid crystal coating layer, and preferably is a solvent which is inert to the polymerization reaction of a composition for a polymerizable liquid crystal coating layer.

The solvent may include an alcohol solvent such as methanol, ethanol, ethylene glycol, isopropylalcohol, propyleneglycol, ethyleneglycolmethylether, ethyleneglycolbutylether, propyleneglycol monomethylether, etc.; an ester solvent such as ethyl acetate, butyl acetate, ethyleneglycolmethylether acetate, γ-butyrolactone, propyleneglycolmethylether acetate, ethyl lactate, etc.; a ketone solvent such as acetone, methylethylketone, cyclopentanone, cyclohexanone, 2-heptanone, methylisobutylketone, etc.;

an aliphatic hydrocarbon solvent such as pentane, hexane, heptane, etc.; an aromatic hydrocarbon solvent such as toluene, xylene, etc.; a nitrile solvent such as acetonitrile, etc.; an ether solvent such as tetrahydrofuran, dimethoxyethane, etc.; and a chlorine-containing solvent such as chloroform, chlorobenzene, or the like. These solvents may be used alone or in a combination of two or more thereof.

A content of the solvent may be the remaining content to 100 parts by weight of the polymerizable liquid crystal compound. Such content range is a range selected by considering a thickness and a state of the formed film.

A method for applying the above-described composition for a liquid crystal coating layer may include extrusion coating, direct gravure coating, reverse gravure coating, CAP coating, die coating, dip coating, bar coating, and spin coating.

In order to offer alignment property to the composition for a liquid crystal coating layer according to an embodiment of the present invention, a non-stretching method such as rubbing, annealing, polarizing UV irradiation, or the like may be used. Such a method may allow the polymerizable liquid crystal compound contained in the composition to be uniformly aligned in a desired direction, and allow the formed layer to have polymerization characteristics. The rubbing is a method of bring a rubbing roll rotating by being wound with a rubbing cloth, into contact with a film carried out by being loaded on a stage. The annealing is a method of exhibiting alignment control force by applying heat. The polarizing UV irradiation is a method of exhibiting polymerization characteristics by irradiating the film with light having any polarized state. The rubbing and the annealing may cause a problem entailed in quality, thus the polarizing UV irradiation is preferably used.

Then, by polymerizing the polymerizable liquid crystal compound included in the film in which the liquid crystal phase is formed, the liquid crystal coating layer 30a may be prepared. The polymerization method may be selected depending on a type of the polymerizable group of the polymerizable liquid crystal compound. When the polymerizable group is a photopolymerizable group, the polymerizable liquid crystal compound may be polymerized by a photopolymerization method, and when the polymerizable group is a thermopolymerizable group, the polymerizable liquid crystal compound may be polymerized by a thermal polymerization method.

As described above, in an embodiment of the present invention, the photopolymerization method is preferably used. In the photopolymerization method, it is not necessary to heat the film at a high temperature, such that a substrate having low heat resistance may be used. The photopolymerization method is performed by irradiating the film in which the liquid crystal phase is formed with visible light, UV light, or laser beam. In terms of ease of handling, the UV light is preferably used. The light irradiation is performed in a state in which the liquid crystal phase is formed in the film. As described above, the irradiation may be performed at a temperature exhibiting the liquid crystal phase. In the case, the pattern may be formed by performing masking, development, or the like.

A thickness of the liquid crystal coating layer 30a of an embodiment of the present invention is preferably 0.3 to 20 μm, more preferably, 0.5 to 10 μm, and most preferably, 0.5 to 5 μm. Within the above range, the alignment property of the polymerizable liquid compound is excellent, and the formation of the pattern may also be easily performed.

In the polarizer according to an embodiment of the present invention, an alignment film (not illustrated) may be formed on the base film 30b. In this case, the composition for a liquid crystal coating layer of an embodiment of the present invention is applied to the alignment film.

It is preferable that the alignment film is not dissolved by the application of the composition for a polymerizable liquid crystal coating layer, or the like according to an embodiment of the present invention, that is, it is preferable that the alignment film has solvent resistance. In addition, it is preferable that the alignment film has heat resistance in removing the solvent, or in heat treatment for alignment of the liquid crystal. Furthermore, an alignment film which is not peeled off due to a friction by rubbing, or the like is preferably used.

It is preferable that the alignment film includes an aligned polymer or a composition containing the aligned polymer.

The aligned polymer may include a polymer such as polyamide or gelatins having an amide bond in a molecule, polyimide having an imide bond in a molecule and polyamic acid which is a hydrolysate thereof, polyvinyl alcohol, alkyl-modified polyvinylalcohol, polyacrylamide, polyoxazole, polyethyleneimine, polystyrene, polyvinylpyrrolidone, polyacrylic acid, polyacrylic acid esters, or the like. Among them, polyvinyl alcohol is preferably used. These polymers may be used alone, in combination of two or more thereof, or as a copolymer of two or more thereof. These polymers may be easily obtained by polycondensation by dehydration or deamination, radical polymerization, chain polymerization such as anionic polymerization and cationic polymerization, coordination polymerization, ring-opening polymerization, or the like.

In this case, the aligned polymer may be dissolved in the solvent and applied. The solvent usable herein may be water; an alcohol solvent such as methanol, ethanol, ethylene glycol, isopropyl alcohol, propylene glycol, methylcellosolve, butylcellosolve, propyleneglycolmonomethylether, etc.; an ester solvent such as ethyl acetate, butyl acetate, ethyleneglycolmethylether acetate, γ-butyrolactone, propyleneglycolmethylether acetate, ethyl lactate, etc.; a ketone solvent such as acetone, methylethylketone, cyclopentanone, cyclohexanone, methylamylketone, methylisobutylketone, etc.; an aliphatic hydrocarbon solvent such as pentane, hexane, heptane, etc.; an aromatic hydrocarbon solvent such as toluene, xylene, etc.; a nitrile solvent such as acetonitrile, etc.; an ether solvent such as tetrahydrofuran, dimethoxyethane, etc.; and a chlorine-substituted hydrocarbon solvent such as chloroform, chlorobenzene, or the like. These organic solvents may be used alone or in a combination of two or more thereof.

Further, in order to form the alignment film, commercially available alignment film materials may be used as it is. The commercially available alignment film materials may include Sunever (Nissan Chemical Industries Ltd.), Optmer (JSR corporation), or the like. When using such an alignment film, smearing may be reduced, such that a polarizer having more improved environmental resistance or mechanical resistance may be provided.

A method for forming the alignment film is the same as the method for offering the alignment property to the liquid crystal coating layer described above. For example, the alignment film may be formed on the base film by applying a solution of the aligned polymer or the commercially available alignment film materials on the base film, and then performing annealing thereon. A thickness of the alignment film prepared as described above may be, for example, 10 to 10000 nm, and preferably, 10 to 1000 nm.

Next, the adhesive layer 10, which is to attach the polarizing plate manufactured according to an embodiment of the present invention onto a panel, or the like, is formed on one surface of the protective layer 20.

As the adhesive layer 10, an adhesive layer having excellent optical transparency and adhesive characteristics such as appropriate wettablity, agglutinability, adhesiveness, or the like, may be used. In particular, an adhesive layer having excellent durability, or the like is preferably used.

As an adhesive suitable for forming the adhesive layer 10, an acrylic copolymer, a silicon copolymer, a rubber copolymer, a urethane copolymer, a polyester copolymer, an epoxy copolymer, or the like may be used, the acrylic copolymer is preferably used, and a pressure-sensitive acrylic adhesive is more preferably used.

As the acrylic adhesive, a resin having (meth)acrylic acid ester such as butyl (meth)acrylate, ethyl (meth)acrylate, isooctyl (meth)acrylate, 2-ethylhexyl (meth)acrylate as a major component unit, or a copolymer resin using two or more of the above (meth)acrylic acid ester are preferably used. Further, the resin is copolymerized with a polar monomer. As the polar monomer, for example, a polymerizable compound having a polar functional group such as carboxyl, hydroxyl, amide, amino, and epoxy groups, such as (meth)acrylic acid, 2-hydroxy propyl (meth)acrylate, 2-hydroxy ethyl (meth)acrylate, (meth)acryl amide, 2-N,N-dimethyl amino ethyl (meth)acrylate, glycidyl (meth)acrylate, or the like, may be used. In general, the adhesive has a cross-linking agent mixed together with an acrylic resin.

In this case, the adhesive composition may include a known antistatic agent such as an ionic compound, a conductive polymer, a metal oxide, CNT, or the like.

The antistatic agent is effective for decreasing or preventing an occurrence of static electricity. In the present invention, any antistatic agent known in the related art may be used without particular limitation thereof.

As the antistatic agent, an ionic compound is preferably used. A type of the ionic compound is not particularly limited so long as it is ionic salts including an anion and a cation, and is capable of offering ion conductivity. Specifically, the ionic compound may include ionic salts including a cation selected from a group consisting of alkali metal salts, ammonium salts, sulfonium salts, and phophonium salts, and an anion selected from a group consisting of fluorine-containing inorganic salts, fluorine-containing organic salts, and iodide ion.

Various additives may be additionally mixed in the adhesive. An appropriate additive may include a silane coupling agent. The silane coupling agent is effective for increasing adhesive force to glass.

As a method for laminating the adhesive layer 10 on the polarizing plate, any method generally known in the related art may be used without particular limitation thereof.

For example, the adhesive layer 10 may be laminated by applying a coating solution for forming the adhesive layer to the surface of the protective layer 20 and then drying the same. The adhesive layer 10 may also be laminated by preparing an adhesive sheet by forming the adhesive layer by the same application method as described above, and then laminating the adhesive sheet using a roll pressing apparatus, on a silicon-coated releasing film. In this case, when the adhesive composition contains a UV-curable compound as a cross-linking agent, it is preferable that UV light is irradiated after applying the adhesive composition, or after laminating by using the roll pressing apparatus.

A thickness of the adhesive layer 10 may be controlled depending on the adhesive force thereof. Generally, the thickness of the adhesive layer 10 is preferably 3 to 100 μm, and more preferably, 10 to 100 μm.

The polarizing plate 100 according to an embodiment of the present invention may further include a surface treatment layer such as a hard coating layer, an anti-reflective layer, an anti-glare layer, an antistatic layer, or the like, which is laminated thereon. In addition, the polarizing plate 100 according to an embodiment of the present invention may further include an optical functional film adhered thereto by the adhesive. The optical functional film may include, for example, an optical compensation film, a reflective polarization separating film, a retardation film, anti-glare functional film, a reflective film, a transflective film, a diffusion control film, a brightness enhancing film, or the like.

In particular, in the polarizing plate according to an embodiment of the present invention, since the protective layer is made of the aqueous composition containing polyvinylalcohol, a decrease in performance of the polarizing plate generated due to using the adhesive may be prevented. Specifically, when using the protective film, a deformation of the protective film itself may occur, and as the layer is added, it may be disadvantageous in terms of reducing the thickness or weight. In addition, the adhesive may also not satisfy the required characteristics, and may be changed depending on the environment in which the polarizing plate is used, such that the polarizing plate may be damaged. However, according to an embodiment of the present invention, the performance of the polarizer may be effectively maintained by forming a protective layer which does not inhibit the optical properties and durability of the polarizing plate using an aqueous solution which is a mixture of polyvinylalcohol and water, as well as, it is very economical in aspects of using an easy process of applying and then drying.

Further, in the structure of the polarizing plate according to an embodiment of the present invention, the polarizer has a form in which the liquid crystal coating layer is applied on the base film, such that problems such as weak durability of the polarizer and a change in dimension resulting therefrom, which are generated due to the stretching process during the manufacturing process of the polarizing plate in the related art, may be basically prevented. As described above, since the liquid crystal coating layer is aligned through the annealing, rubbing, light irradiation, or the like, the polarizer has excellent durability, and thereby a change in optical characteristics is decreased.

Such effects are confirmed through a fact that change amounts of transmittance and degree of polarization of the polarizing plate according to an embodiment of the present invention were measured as 1.0% or less, respectively, in measurement in which the polarizing plate according to an embodiment of the present invention is left under a dry condition at 85° C. for 100 hours and left under a condition of 90% RH at 60° C. for 100 hours.

An embodiment of the present invention also provides a display device including the polarizing plate. The display device is a device having display elements, and includes light emitting elements or light emitting devices as a light emitting source. The display device may include a liquid crystal display, an organic electroluminescent (EL) display, an inorganic electroluminescent (EL) display, an electron emission display (for example, a field emission display (FED) and a surface-conduction electron-emitter display (SED)), an electronic-paper (a display using Electronic ink or electrophoresis device), a plasma display, a projection type display (for example, a grating light valve (GLV) display, a display having a digital micromirror device (DMD)), and a piezoelectric ceramic display. The liquid crystal display may include a transmissive liquid crystal display, a transflective liquid crystal display, a reflective liquid crystal display, a direct view liquid crystal display, and a projection type liquid crystal display. The display device may be a device displaying 2-dimensional image, and may also be a stereoscopic device displaying 3-dimensional image.

Hereinafter, exemplary embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Examples 1 to 5 and Comparative Examples 1 and 2

### Manufacturing of Polarizing Plate

### Example 1

A alignment film having a thickness of 100 nm was formed by applying a composition for an aligned coating layer on a triacetyl cellulose (TAC) base film having a thickness of 40 μm using a bar coating method, followed by drying at 60° C. for 1 minute. In this case, as the composition for an aligned coating layer, a solution obtained by dissolving a polymer (Formula 1-1 or Formula 1-2 below) having a photoreactive group in cyclopentanone, in a concentration of 5 wt. %, was used. The obtained film was irradiated with polarized light obtained by passing light having intensity of 100 mJ measured at a wavelength of 365 nm using a UV irradiation apparatus (SPOT Cure SP-7, manufactured by Ushio Electric Inc.) through a wire grid (UIS-27132##, Ushio Electric Inc.) to off alignment property, the composition for a liquid crystal coating layer was applied thereto using the bar coating method, followed by heat drying at 120° C. for 1 minute, and was cooled to room temperature to obtain a dried film, and the dried film was irradiated with light (in an exposure amount of 1200 mJ based on 365 nm), thereby fabricating a polarizer. In this case, the composition for a liquid crystal coating layer was prepared by mixing 100 parts by weight of a polymerizable liquid crystal compound (Formula 2-1 below), 2 parts by weight of an azo dye (NKX2029, manufactured by Hayashibara Biochemical Laboratories, Inc.) as a dichroic dye, parts by weight of 2-dimethylamino-2-benzyl-1-(4-morpholinophenyl)butane-1-one (Irgacure 369, manufactured by BASF Co. Japan) as a polymerization initiator, 2 parts by weight of isopropyl thioxanthone (manufactured by Siber Hegner & Co, Japan) as a polymerization initiator aid, and 1.2 parts by weight of a polyacrylate compound (BYK-361N; manufactured by BYK-Chemie Co.) as a leveling agent in cyclopentanone which is a solvent, and stirring the mixture at 80° C. for 1 hour.

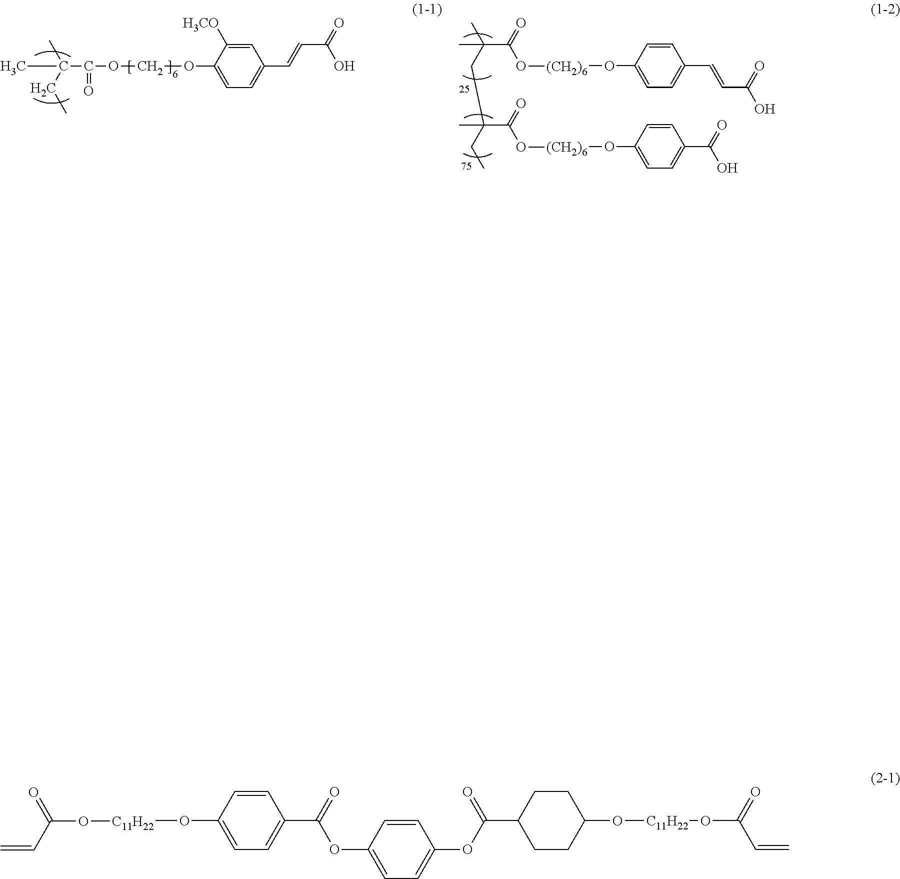

A mixture of polyvinylalcohol (Z-200, manufactured by Nippon Goshei Co., Ltd) and water (3.5:100) was applied to the fabricated liquid crystal coating layer of the polarizer, and dried at 120° C. for 2 minutes to prepare a protective layer having a thickness of 0.5 μm.

An adhesive (LS192NP; manufactured by Lintec Co.) was attached on the prepared protective layer using a nip roll, to fabricate a polarizing plate.

### Example 2

The same procedures as described in Example 1 were conducted to fabricate a polarizing plate except that a protective layer having a thickness of 0.7 μm after drying was used.

### Example 3

The same procedures as described in Example 1 were conducted to fabricate a polarizing plate except that the protective layer was formed so as to have a thickness of 1.5 μm after drying.

### Example 4

The same procedures as described in Example 1 were conducted to fabricate a polarizing plate except that polyvinylalcohol (KL318, Kuraray Co., Ltd.) was used for preparing the composition of a protective layer instead of polyvinylalcohol (Z-200).

### Example 5

The same procedures as described in Example 1 were conducted to fabricate a polarizing plate except that a ratio of polyvinylalcohol and water was changed into 5:100 in the composition of a protective layer.

### Comparative Example 1

The same procedures as described in Example 1 were conducted to fabricate a polarizing plate except that the protective layer was not formed.

### Comparative Example 2

The same procedures as described in Example 1 were conducted to fabricate a polarizing plate except that the protective layer was formed on the polarizing layer by applying a solution prepared by dissolving 50 parts by weight of dipentaerythritol hexaacrylate (Aronix M-403, manufactured by Toagosei Co., Ltd), 50 parts by weight of an acrylate resin (Ebecryl 4858, manufactured by Daicel UCB Co., Ltd), and 3 parts by weight of 2-methyl-1[4-(methylthio)phenyl]-2-morpolynopropane-1-one (Irgacure 907, manufactured by Ciba Specialty Chemicals Inc.) in 250 parts by weight of isopropanol, using a bar coating method, followed by heat drying in a drying oven at 50° C. for 1 minute, and the dried film was irradiated with UV light (in an exposure amount of 400 mJ/cm² based on 365 nm), using a UV irradiation apparatus (SPOT Cure SP-7, manufactured by Ushio Electric Inc.).

### Experimental Example

### Measurement of Properties

Properties of the polarizing plates fabricated in the examples and comparative examples are evaluated, and the results thereof are listed in Tables 1 and 2 below.

(1) Measurement of Change Amount of Transmittance

Samples were prepared by cutting the polarizing plates fabricated in the examples and comparative examples so as to have a size of 40 mm in an absorption axis direction and 40 mm in a direction orthogonal to the absorption axis, respectively, and attaching the cut polarizing plates to a glass plate through an adhesive adhered therebetween. Transmittance of samples was measured by using a spectrophotometer (V7100, manufactured by Jasco Inc.) at a visible ray region. Thereafter, the samples were left under a high temperature dry atmosphere at 85° C. and a heated and humidified atmosphere of 90% RH at 60° C. for 100 hours, respectively, and transmittance thereof was measured in the same manner as described above.

(2) Measurement of Change Amount of Degree of Polarization

Samples were prepared by cutting the polarizing plates prepared in the examples and comparative examples so as to have a size of 40 mm in an absorption axis direction and 40 mm in a direction orthogonal to the absorption axis, respectively, and attaching the cut polarizing plates to a glass plate through an adhesive adhered therebetween. Transmittance of samples was measured by using a spectrophotometer (V7100, manufactured by Jasco Lnc.). Thereafter, the samples were left under a high temperature dry atmosphere at 85° C. and a heated and humidified atmosphere of 90% RH at 60° C. for 100 hours, respectively, and transmittance thereof was measured in the same manner as described above.

TABLE 1

| | | | | | Degree of | | |
|---|---|---|---|---|---|---|---|
| | | Transmittance (%) | | | polarization (%) | | |
| | | | After leaving | | | After leaving | |
| | | | in dried | | | in dried | |
| | | | atmosphere at | | | atmosphere at | |
| | Thickness | | 85° C. for | Change | | 85° C. for | Change |
| Section | (um) | Initial | 100 hours | amount | Initial | 100 hours | amount |
| Example 1 | 0.5 | 42.8 | 41.9 | 0.9 | 95.6 | 94.8 | 0.8 |
| Example 2 | 0.7 | 42.7 | 42.1 | 0.6 | 95.6 | 95.3 | 0.3 |
| Example 3 | 1.5 | 42.9 | 42.2 | 0.7 | 96.0 | 95.5 | 0.5 |
| Example 4 | 0.5 | 42.6 | 41.8 | 0.8 | 96.3 | 95.8 | 0.5 |
| Example 5 | 0.5 | 42.8 | 42.0 | 0.8 | 96.5 | 95.7 | 0.8 |
| Comparative | — | 42.8 | 35.7 | 7.1 | 96.6 | 89.8 | 5.8 |
| Example 1 | | | | | | | |
| Comparative | 0.5 | 41.4 | 40.5 | 0.9 | 95.0 | 94.0 | 1.0 |
| Example 2 | | | | | | | |

TABLE 2

| | | | | | Degree of | | |
|---|---|---|---|---|---|---|---|
| | | Transmittance (%) | | | polarization (%) | | |
| | | | After | | | After | |
| | | | leaving in | | | leaving in | |
| | | | humidified | | | humidified | |
| | | | atmosphere of | | | atmosphere of | |
| | | | 90% RH at | | | 90% RH at | |
| | Thickness | | 60° C. for | Change | | 60° C. for | Change |
| Section | (um) | Initial | 100 hours | amount | Initial | 100 hours | amount |
| Example 1 | 0.5 | 42.7 | 41.7 | 1.0 | 95.7 | 95.0 | 0.7 |
| Example 2 | 0.7 | 42.2 | 41.5 | 0.8 | 95.9 | 95.4 | 0.5 |
| Example 3 | 1.5 | 42.4 | 41.7 | 0.6 | 95.6 | 95.2 | 0.4 |
| Example 4 | 0.5 | 42.8 | 42.0 | 0.8 | 96.3 | 95.8 | 0.5 |
| Example 5 | 0.5 | 42.8 | 42.1 | 0.7 | 95.8 | 94.9 | 0.9 |
| Comparative | — | 42.8 | 37.2 | 5.6 | 95.7 | 93.3 | 2.4 |
| Example 1 | | | | | | | |
| Comparative | 0.5 | 41.5 | 40.5 | 1.0 | 95.5 | 94.8 | 0.7 |
| Example 2 | | | | | | | |

Referring to the above Tables 1 and 2, it could be seen that the polarizing plate including the polarizer according to an embodiment of the present invention had a value of 1.0% or less of changes in transmittance and degree of polarization, before and after being left under the high temperature and/or high humidity atmosphere as compared to Comparative Example 1, such that the optical performance of the polarizing plate was effectively maintained in a required level. Further, regarding effects of the composition of a protective layer, it could be seen that, since the composition of a protective layer of the polarizing plate fabricated in Comparative Example 2 was not aqueous composition, degradation in optical performance already appeared when the polarizing plate was completed.

The polarizing plate according to an embodiment of the present invention has the protective layer made of the aqueous composition, and the stretching process is not executed during manufacturing, therefore the polarizing plate having excellent durability and stable optical characteristics may be implemented. Further, the polarizing plate may be applied to various display devices to implement high image quality.

What is claimed is:

1. A polarizing plate, comprising:
an adhesive layer;
a protective layer made of an aqueous composition containing polyvinylalcohol; and
a polarizer comprising a base film and a liquid crystal coating layer formed on one surface of the base film, the liquid crystal coating layer having alignment property offered by a non-stretching method;
wherein, the adhesive layer, the protective layer, and the polarizer are laminated sequentially.

2. The polarizing plate according to claim 1, wherein the polyvinylalcohol is included in an amount of 1 to 10% by weight, to 100% by weight of the aqueous composition.

3. The polarizing plate according to claim 1, wherein the protective layer is formed by applying the aqueous composition and then drying the same.

4. The polarizing plate according to claim 1, wherein the protective layer has a thickness of 0.5 to 3.0 μm after drying.

5. The polarizing plate according to claim 1, wherein the base film is a transparent polymer film.

6. The polarizing plate according to claim 1, wherein the liquid crystal coating layer includes a polymerizable liquid crystal compound and a dichroic dye.

7. The polarizing plate according to claim 1, wherein the adhesive layer includes one selected from a group consisting of an acrylic copolymer, epoxy resin, urethane resin, silicon resin, polyether resin, polyester resin, polyamide resin, polyvinylalcohol resin, and a combination thereof.

8. The polarizing plate according to claim 1, wherein a change amount of transmittance before and after being left under a high temperature or high humidity atmosphere is 1.0% or less.

9. The polarizing plate according to claim 1, wherein a change amount of degree of polymerization before and after being left under a high temperature or high humidity atmosphere is 1.0% or less.

10. A display device comprising: the polarizing plate according to claim 1.
